(19) United States
(12) Patent Application Publication
(10) Pub. No.: US 2009/0179081 A1
(43) Pub. Date: Jul. 16, 2009

(54) Spray Gun with Low Emissions Technology

(75) Inventor: Mark E. Charpie, Ottawa Lake, MI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS INC., Glenview, IL (US)

(21) Appl. No.: 12/014,722

(22) Filed: Jan. 15, 2008

(51) Int. Cl. B05B 17/04; B05B 17/00; B05B 15/00; B05B 7/12; B05D 1/02; B05C 11/00

(52) U.S. Cl. 239/11; 239/526; 239/289; 118/668; 427/421.1

(57) ABSTRACT

A spray gun, in one embodiment, is provided with a sensor configured to monitor distance between the spray gun and a target object, and a drive responsive to the sensor, wherein the drive is configured to control a fluid valve of the spray gun based on the distance. A retrofit kit, in another embodiment, is provided with a feedback-controlled system configured to change fluid flow of a spray gun in response to one or more sensed parameters indicative of condition of a target object, a relationship between the spray gun and the target object, or a combination thereof. A spray controller, in a further embodiment, is provided with a control configured to terminate or decrease fluid flow of a spray in response to a first spray stroke away from a target object, and configured to start, continue, or increase fluid flow of the spray in response to a second spray stroke toward the target object. In yet another embodiment, a method of operation is provided for controlling fluid flow in response to feedback associated with a target object. In addition, a tangible medium is provided with instructions stored on the tangible medium, wherein the instructions comprise code configured to terminate or decrease fluid flow of a spray if the spray is not directed toward a target object, and code configured to start, continue, or increase fluid flow of the spray if the spray is directed toward the target object.

### FIELD OF THE INVENTION

The invention relates generally to spray devices and, more particularly, to the transfer efficiency of spray guns.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The objective when spraying paint is to maximize the amount of coating material that is deposited on the substrate and minimize the amount that goes into the atmosphere. High volume low pressure (HVLP) and high transfer efficiency (HTE) spray guns have been designed and mandated in many jurisdictions to limit the amount of overspray due to the paint bouncing back off the substrate. However, there is another major reason for overspray that has not been addressed. This is overspray created when the spray gun is triggered, but not pointed at the substrate. This is a common occurrence in the automotive refinishing business. For example, if a painter is painting the hood of a car, the painter should trigger the fluid off at the end of the stroke and trigger the fluid back on for the return stroke. This avoids spraying paint into the air at the end of each stroke. However, the painters find it easier to hold the trigger fully open as they reach the end of the stroke and reverse directions. This practice can lead to significantly higher material costs and significantly higher volatile organic compound (VOC) emissions into the atmosphere.

### BRIEF DESCRIPTION

A spray gun, in one embodiment, is provided with a sensor configured to monitor distance between the spray gun and a target object, and a drive responsive to the sensor, wherein the drive is configured to control a fluid valve of the spray gun based on the distance. A retrofit kit, in another embodiment, is provided with a feedback-controlled system configured to change fluid flow of a spray gun in response to one or more sensed parameters indicative of condition of a target object, a relationship between the spray gun and the target object, or a combination thereof. A spray controller, in a further embodiment, is provided with a control configured to terminate or decrease fluid flow of a spray in response to a first spray stroke away from a target object, and configured to start, continue, or increase fluid flow of the spray in response to a second spray stroke toward the target object. In yet another embodiment, a method of operation is provided for controlling fluid flow in response to feedback associated with a target object. In addition, a tangible medium is provided with instructions stored on the tangible medium, wherein the instructions comprise code configured to terminate or decrease fluid flow of a spray if the spray is not directed toward a target object, and code configured to start, continue, or increase fluid flow of the spray if the spray is directed toward the target object.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram illustrating an embodiment of a spray coating system;

FIG. 2 is a flow chart illustrating an embodiment of a spray coating process; and

FIGS. 3 and 4 are cross-sectional side views of different embodiments of a spray coating device used in the spray coating system and method of FIGS. 1 and 2.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

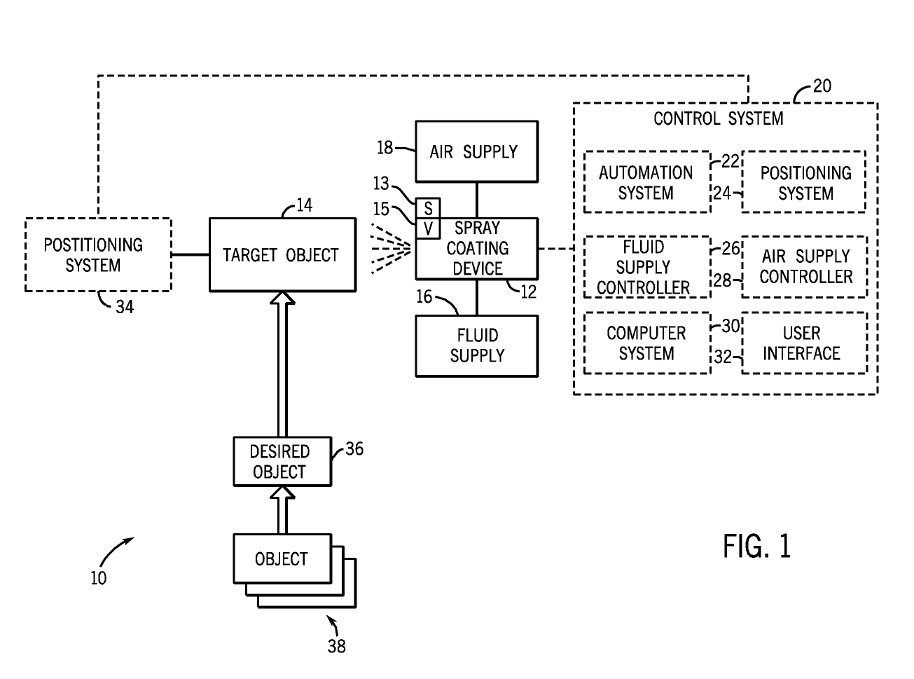

FIG. 1 is a flow chart illustrating an exemplary spray coating system 10, which includes a spray coating gun 12 for applying a desired coating to a target object 14. In certain embodiments, the spray coating gun 12 may include an air atomizer, a rotary atomizer, an electrostatic atomizer, or any other suitable spray formation mechanism. As discussed in detail below, the spray coating gun 12 includes one or more sensors (S) 13 coupled to one or more valves (V) 15, such that the spray coating gun 12 automatically controls fluid flow through the valves 15 in response to sensor feedback from the sensors 13. As discussed in detail below, the sensor 13 may monitor distance, presence and absence, stroke direction, stroke velocity, or a combination thereof, of the target object 14 relative to the spray coating gun 12. In response, the valve 15 automatically closes when the spray coating gun 12 is pointed away from the target object 14 (e.g., into air) and automatically opens when the spray coating gun 12 is pointed at the target object 14. The valve 15 also may increase fluid flow in response to sensor 13 feedback indicative of a distance increase, an optimal or improving spray angle, an optimal or improving surface (e.g., flat), an optimal or increasing temperature, and so forth. On the other hand, the valve 15 may decrease fluid flow in response to sensor 13 feedback indicative of a distance decrease, a poor or worsening spray angle, a poor or worsening surface (e.g., multiple angles, corner, etc.), a poor or decreasing temperature, and so forth.

The spray coating gun 12 may be coupled to a variety of supply and control systems, such as the fluid supply 16, an air supply 18, and a control system 20. The control system 20 facilitates control of the fluid and air supplies 16 and 18 and ensures that the spray coating gun 12 provides an acceptable quality spray coating on the target object 14. For example, the control system 20 may include an automation system 22, a positioning system 24, a fluid supply controller 26, an air supply controller 28, a computer system 30, and a user interface 32. The control system 20 also may be coupled to a positioning system 34, which facilitates movement of the target object 14 relative to the spray coating gun 12. Accordingly, the spray coating system 10 may provide a computer-controlled mixture of coating fluid, fluid and air flow rates, and spray pattern. Moreover, the positioning system 34 may include a robotic arm controlled by the control system 20, such that the spray coating gun 12 covers the entire surface of the target object 14 in a uniform and efficient manner.

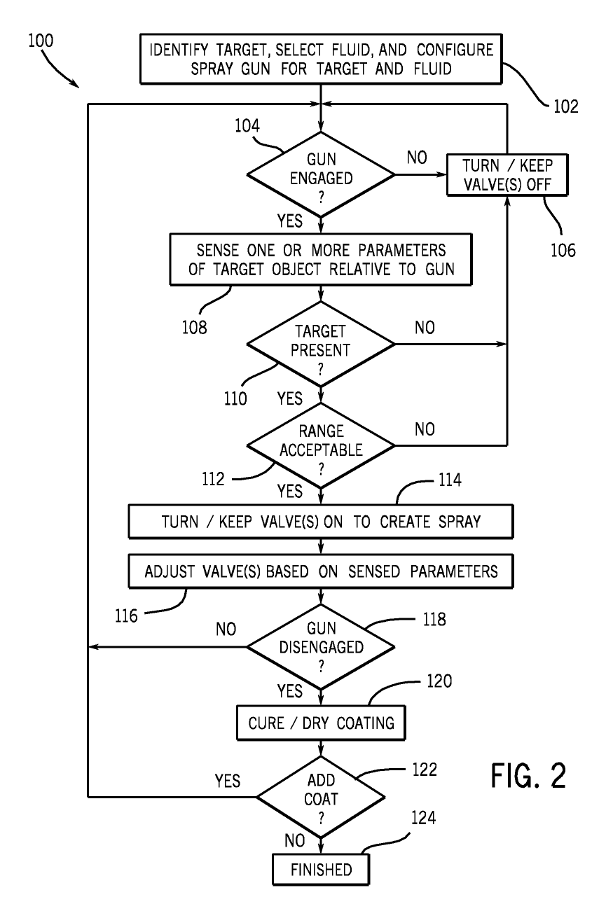

FIG. 2 is a flow chart of an embodiment of a spray coating process 100 for applying a desired spray coating to the target object 14. As illustrated, the process 100 proceeds by identifying a target object 14, selecting a desired fluid for application to a spray surface of the target object 14, and configuring a spray coating gun 12 for the identified target object 14 and selected fluid (block 102). In the illustrated embodiment, the process 100 then queries for an engagement state of the spray coating gun 12 (block 104). For example, the process 100 may monitor whether or not a user manually pulls a trigger, button, or other actuator intended to initiate a spray from the spray coating gun 12. At block 104, if the process 100 determines that the gun 12 (e.g., trigger) is not engaged, then the process 100 may proceed to turn off (or maintain an off state of) valves that control fluid flow through the spray coating gun 12 (block 106). Otherwise, if the process 100 determines that the gun 12 (e.g., trigger) is engaged, then the process 100 may proceed to sense (e.g., monitor) one or more parameters of the target object 14 relative to the spray coating gun 12 (block 108). For example, the sensed parameters may include the presence or absence of the target object 14 within a field of view (e.g., spray direction and/or area), a distance between the target object 14 and the spray coating gun 12, a stroke velocity and/or acceleration of the spray coating gun 12 relative to the target object 14, a stroke direction of the spray coating gun 12 relative to target object 14, an angle of the spray coating gun 12 relative to the target object 14, a surface wetness of the target object 14, a surface morphology of the target object 14, a surface temperature of the target object 14, and so forth. The sensing block 108 may include laser, infrared, photoelectric, optical, fiber optic, electromagnetic or electrostatic, microwave, capacitive, piezoelectric, or ultrasonic sensing, or any combination thereof. As discussed further below, the sensor feedback may be used by the process 100 to control fluid flow through the spray coating gun 12 to improve transfer efficiency, improve uniformity of the spray coating, reduce waste, and so forth.

Based on the sensed parameters 108, the illustrated process 100 proceeds to evaluate whether or not the target object 14 is present within the field of view of the spray coating gun 12 (block 110). If the target 14 is not present (e.g., out of the field of view), then the process 100 responds by turning off (or maintaining an off position of) the valves that control fluid flow through the spray coating gun 12 (block 106). If the target 14 is present (e.g., within the field of view), then the process 100 continues by evaluating whether or not the target object 14 is within an acceptable range (e.g., distance) relative to the spray coating gun 12 (block 112). If the range is not acceptable at block 112, then the process 100 responds by turning off (or maintaining an off position of) the valves that control fluid flow through the spray coating gun 12 (block 106). For example, if the target object 14 is at a distance greater than a maximum distance or less than a minimum distance relative to the spray coating gun 12, then the process 100 does not form a spray coating. In some embodiments, the process 100 may respond by setting off an alarm (e.g., audio and/or visual) to alert the user without terminating the spray.

If the range is acceptable at block 112, then the process 100 responds by turning on (or maintaining an on position of) the valves to create a spray downstream from the spray coating gun 12 (block 114). In turn, the process 100 may adjust the valves and various other controllable features of the spray coating gun 12 based on the sensed parameters (block 116). For example, the process 100 may increase the fluid flow and spray density as the distance increases between the spray coating gun 12 and the target object 14. Similarly, the process 100 may decrease the fluid flow and spray density as the distance decreases between the spray coating gun 12 and the target object 14. The process 100 may vary the liquid flow rate of the coating fluid and also features that control the atomization and shaping of the spray downstream from the spray coating gun 12. For example, the process 100 may adjust the air flow rate to an atomization orifice surrounding a central liquid exit, a plurality air shaping orifices, a pneumatically controlled valve, and so forth. In some embodiments, the process 100 may increase the liquid flow rate in response to a greater stroke velocity of the spray coating gun 12 relative to the target object 14, and decrease the liquid flow rate in response to a lesser stroke velocity of the spray coating gun 12 relative to the target object 14.

The process 100 continues to sense the parameters and control the fluid flow as indicated by blocks 104-116 until the gun is disengaged (block 118). If the spray coating gun 12 is not disengaged at block 118, then the process 100 continues in a closed loop by returning to block 104. Otherwise, if the spray coating gun 12 is disengaged at block 118, then the process 100 proceeds to cure/dry the coating applied over the desired surface (block 120). If an additional coating (e.g., same or different coating) is desired by the user at query block 122, then process 100 proceeds through blocks 104-120 to provide another coating of fluid. If the user does not desire an additional coating at query block 122, then process 100 is finished at block 124.

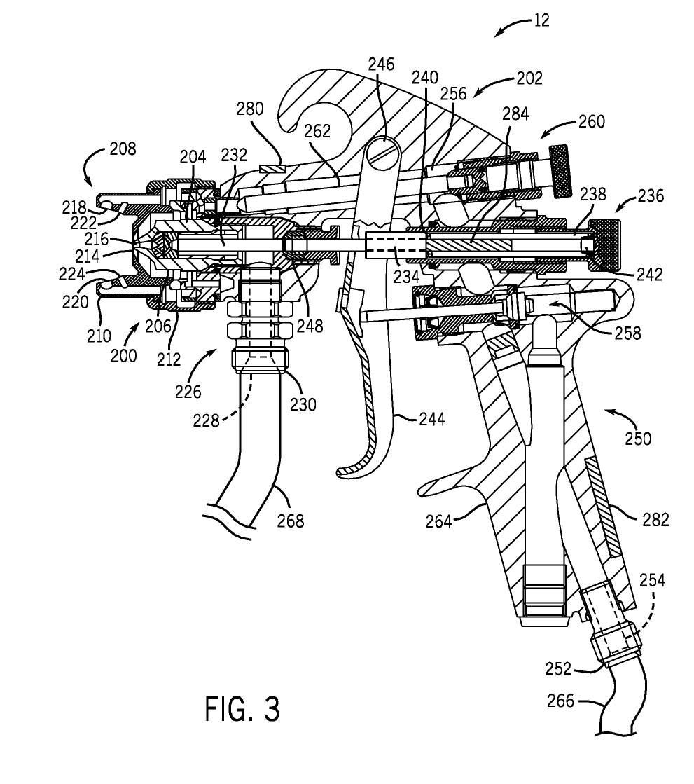

FIG. 3 is a cross-sectional side view illustrating an exemplary embodiment of the spray coating gun 12. As illustrated, the spray coating gun 12 includes a spray tip assembly 200 coupled to a body 202. The spray tip assembly 200 includes a fluid delivery tip assembly 204, which may be removably inserted into a receptacle 206 of the body 202. For example, a plurality of different types of spray coating devices may be configured to receive and use the fluid delivery tip assembly 204. The spray tip assembly 200 also includes a spray formation assembly 208 coupled to the fluid delivery tip assembly 204. The spray formation assembly 208 may include a variety of spray formation mechanisms, such as air, rotary, and electrostatic atomization mechanisms. However, the illustrated spray formation assembly 208 comprises an air atomization cap 210, which is removably secured to the body 202 via a retaining nut 212. The air atomization cap 210 includes a variety of air atomization orifices, such as a central atomization orifice 214 disposed about a fluid tip exit 216 from the fluid delivery tip assembly 204. The air atomization cap 210 also may have one or more spray shaping orifices, such as spray shaping orifices 218, 220, 222, and 224, which force the spray to form a desired spray pattern (e.g., a flat spray). The spray formation assembly 208 also may comprise a variety of other atomization mechanisms to provide a desired spray pattern and droplet distribution.

The body 202 of the spray coating gun 12 includes a variety of controls and supply mechanisms for the spray tip assembly 200. As illustrated, the body 202 includes a fluid delivery assembly 226 having a fluid passage 228 extending from a fluid inlet coupling 230 to the fluid delivery tip assembly 204. The fluid delivery assembly 226 also comprises a fluid valve assembly 232 to control fluid flow through the fluid passage 228 and to the fluid delivery tip assembly 204. The illustrated fluid valve assembly 232 has a needle valve 234 extending movably through the body 202 between the fluid delivery tip assembly 204 and a fluid valve adjuster 236. The fluid valve adjuster 236 is rotatably adjustable against a spring 238 disposed between a rear section 240 of the needle valve 234 and an internal portion 242 of the fluid valve adjuster 236. The needle valve 234 is also coupled to a trigger 244, such that the needle valve 234 may be moved inwardly away from the fluid delivery tip assembly 204 as the trigger 244 is rotated counter clockwise about a pivot joint 246. However, any suitable inwardly or outwardly openable valve assembly may be used within the scope of the present technique. The fluid valve assembly 232 also may include a variety of packing and seal assemblies, such as packing assembly 248, disposed between the needle valve 234 and the body 202.

An air supply assembly 250 is also disposed in the body 202 to facilitate atomization at the spray formation assembly 208. The illustrated air supply assembly 250 extends from an air inlet coupling 252 to the air atomization cap 210 via air passages 254 and 256. The air supply assembly 250 also includes a variety of seal assemblies, air valve assemblies, and air valve adjusters to maintain and regulate the air pressure and flow through the spray coating gun 12. For example, the illustrated air supply assembly 250 includes an air valve assembly 258 coupled to the trigger 244, such that rotation of the trigger 244 about the pivot joint 246 opens the air valve assembly 258 to allow air flow from the air passage 254 to the air passage 256. The air supply assembly 250 also includes an air valve adjustor 260 coupled to a needle 262, such that the needle 262 is movable via rotation of the air valve adjustor 260 to regulate the air flow to the air atomization cap 210. As illustrated, the trigger 244 is coupled to both the fluid valve assembly 232 and the air valve assembly 258, such that fluid and air simultaneously flow to the spray tip assembly 200 as the trigger 244 is pulled toward a handle 264 of the body 202. Once engaged, the spray coating gun 12 produces an atomized spray with a desired spray pattern and droplet distribution. As further illustrated, an air conduit 266 is coupled to the air inlet coupling 252 and a fluid conduit 268 is coupled to the fluid inlet coupling 230.

In this particular embodiment, the rate of fluid flow delivered from the fluid delivery assembly 226 may be adjusted based on one or more sensed parameters (e.g., distance, velocity, acceleration, angle, direction, etc.) between the spray coating gun 12 and the target object 14. The parameters between the spray coating gun 12 and the target object 14 may be determined by way of a sensor 280 attached to the spray coating gun 12 directly behind the spray tip assembly 200 and on the body 202 of the spray coating gun 12. The position of the sensor 280 behind the spray tip assembly 200 and on the body 202 of the spray coating gun 12 enables removal of the spray tip assembly 200 without disturbing the placement of the sensor 280. The sensor 280 may be capable of sensing the presence or absence of the target object 14. More specifically, the sensor 280 may be configured to monitor distance, velocity, acceleration, angle, direction, or a combination thereof, between the spray coating gun 12 and the target object 14. The sensor 280 may be of any type including, but not limited to, laser, infrared, photoelectric, optical, fiber optic, electromagnetic or electrostatic, microwave, capacitive, piezoelectric, and ultrasonic sensors.

For example, once the distance between the spray coating gun 12 and the target object 14 is determined, the sensor 280 may communicate this distance to a programmable logic controller (PLC) or other automated input/output arrangement. The logic controller 282 may reside either on the spray coating gun 12 or at a remote location to the spray coating gun 12. The logic controller 282 may determine, based on the distance between the spray coating gun 12 and the target object 14, whether the fluid flow rate delivered from the fluid delivery assembly 226 should be adjusted. For instance, if the distance between the spray coating gun 12 and the target object 14 cannot be determined (e.g., no presence detected), the fluid flow rate delivered from the fluid delivery assembly 226 may be stopped until such time that the distance between the spray coating gun 12 and target object 14 can be determined. In addition, the fluid flow rate delivered from the fluid delivery assembly 226 may be varied based on the distance between the spray coating gun 12 and the target object 14. For instance, if the distance between the spray coating gun 12 and the target object 14 decreases, the fluid flow rate delivered from the fluid delivery assembly 226 may be decreased. Similarly, if the distance between the spray coating gun 12 and the target object 14 increases (e.g., within a suitable range while the target object 14 is within a field of view of the spray coating gun 12), the fluid flow rate delivered from the fluid delivery assembly 226 may be increased. In either case, the automatic flow control may be subject to limits, e.g., upper and lower, in both the flow rates and distances for outputting a spray. In other words, if the spray coating gun 12 is either too close or too distant from the target object 14, then the sensor 280 feedback may trigger an automatic shutoff, an alarm, a delayed shutoff, or another suitable corrective action in response.

The fluid flow rate delivered from the fluid delivery assembly 226 may be varied by communicating with a drive 284 located within the internal portion 242 of the fluid valve adjuster 236. The drive 284 may be actuated to counteract the inward movement of the needle valve 234 away from the fluid delivery tip assembly 204. In addition, it may be desirable to actuate the drive 284 without disturbing the position of the trigger 244. In one embodiment, the needle valve 234 and the drive 284 may be configured such that the drive 284 causes the fluid valve assembly 232 to move toward the fluid delivery tip assembly 204 without moving the needle valve 234. For example, the needle valve 234 may be configured to allow the drive 284 to slide coaxially through the needle valve 234 when the drive 284 is actuated. This could be accomplished using a mechanism within the needle valve 234 which allows an inner portion of the needle valve 234 to separate from an outer portion of the needle valve 234. The outer portion of the needle valve 234 would stay in position while the inner portion of the needle valve 234 moves coaxially with the drive 284. In such an embodiment, the trigger 244 would not experience the force exerted by the drive 284. Therefore, the user would not be aware when the drive 284 overrides the user's depression of the trigger 244. It should be noted that this particular embodiment for actuating the drive 284 and for maintaining the position of the trigger 244 while actuating the drive 284 is merely illustrative and should not be construed as limiting. Other embodiments for carrying out these general objectives may be implemented. It should also be noted that the drive 284 may be an electronic drive, pneumatic drive, hydraulic drive, or any combination thereof.

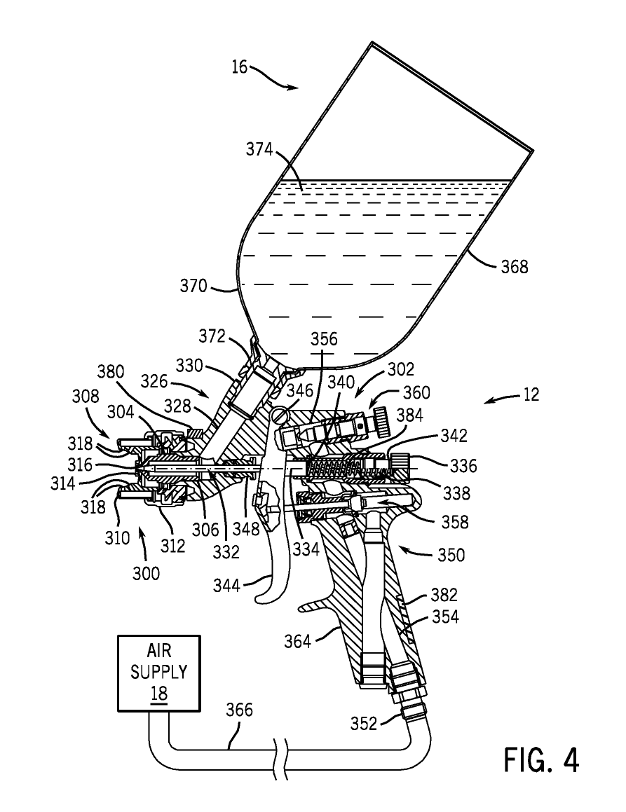

FIG. 4 is a cross-sectional side view illustrating an alternative embodiment of the spray coating gun 12. As illustrated, the spray coating gun 12 includes a spray tip assembly 300 coupled to a body 302. The spray tip assembly 300 includes a fluid delivery tip assembly 304, which may be removably inserted into a receptacle 306 of the body 302. For example, a plurality of different types of spray coating devices may be configured to receive and use the fluid delivery tip assembly 304. The spray tip assembly 300 also includes a spray formation assembly 308 coupled to the fluid delivery tip assembly 304. The spray formation assembly 308 may include a variety of spray formation mechanisms, such as air, rotary, and electrostatic atomization mechanisms. However, the illustrated spray formation assembly 308 comprises an air atomization cap 310, which is removably secured to the body 302 via a retaining nut 312. The air atomization cap 310 includes a variety of air atomization orifices, such as a central atomization orifice 314 disposed about a fluid tip exit 316 from the fluid delivery tip assembly 304. The air atomization cap 310 also may have one or more spray shaping orifices, such as spray shaping orifices 318, which force the spray to form a desired spray pattern (e.g., a flat spray). The spray formation assembly 308 also may comprise a variety of other atomization mechanisms to provide a desired spray pattern and droplet distribution.

The body 302 of the spray coating gun 12 includes a variety of controls and supply mechanisms for the spray tip assembly 300. As illustrated, the body 302 includes a fluid delivery assembly 326 having a fluid passage 328 extending from a fluid inlet coupling 330 to the fluid delivery tip assembly 304. The fluid delivery assembly 326 also comprises a fluid valve assembly 332 to control fluid flow through the fluid passage 328 and to the fluid delivery tip assembly 304. The illustrated fluid valve assembly 332 has a needle valve 334 extending movably through the body 302 between the fluid delivery tip assembly 304 and a fluid valve adjuster 336. The fluid valve adjuster 336 is rotatably adjustable against a spring 338 disposed between a rear section 340 of the needle valve 334 and an internal portion 342 of the fluid valve adjuster 336. The needle valve 334 is also coupled to a trigger 344, such that the needle valve 334 may be moved inwardly away from the fluid delivery tip assembly 304 as the trigger 344 is rotated counter clockwise about a pivot joint 346. However, any suitable inwardly or outwardly openable valve assembly may be used within the scope of the present technique. The fluid valve assembly 332 also may include a variety of packing and seal assemblies, such as packing assembly 348, disposed between the needle valve 334 and the body 302.

An air supply assembly 350 is also disposed in the body 302 to facilitate atomization at the spray formation assembly 308. The illustrated air supply assembly 350 extends from an air inlet coupling 352 to the air atomization cap 310 via air passages 354 and 356. The air supply assembly 350 also includes a variety of seal assemblies, air valve assemblies, and air valve adjusters to maintain and regulate the air pressure and flow through the spray coating gun 12. For example, the illustrated air supply assembly 350 includes an air valve assembly 358 coupled to the trigger 344, such that rotation of the trigger 344 about the pivot joint 346 opens the air valve assembly 358 to allow air flow from the air passage 354 to the air passage 356. The air supply assembly 350 also includes an air valve adjustor 360 to regulate the air flow to the air atomization cap 310. As illustrated, the trigger 344 is coupled to both the fluid valve assembly 332 and the air valve assembly 358, such that fluid and air simultaneously flow to the spray tip assembly 300 as the trigger 344 is pulled toward a handle 364 of the body 302. Once engaged, the spray coating gun 12 produces an atomized spray with a desired spray pattern and droplet distribution.

In the illustrated embodiment of FIG. 4, the air supply 18 is coupled to the air inlet coupling 352 via air conduit 366. Again, embodiments of the air supply 18 may include an air compressor, a compressed air tank, a compressed inert gas tank, or a combination thereof. In contrast to the embodiment of FIG. 3, the illustrated embodiment of FIG. 4 has the fluid supply 16 directly mounted to the spray coating gun 12. In other words, the fluid supply 16 is arranged in an on-gun configuration, such that the user can add the fluid mixture without putting down the gun 12 and/or without substantially delaying the spray process. The illustrated fluid supply 16 includes a gravity feed canister or cup 368 coupled to the fluid inlet coupling 330 on a top side of the body 302. The fluid supply 16 may be described as a top-mounted on-gun configuration. The cup 368 has a tapered portion 370, which leads to an outlet connector 372 coupled to the fluid inlet coupling 330. The fluid supply 16 may include a filtered vent, a collapsible wall portion, an air supply, or a pressure balancer to facilitate the gravity feed.

Similar to the embodiment of FIG. 3, the rate of fluid flow delivered from the fluid delivery assembly 326 may be adjusted based on one or more sensed parameters (e.g., distance, velocity, acceleration, angle, direction, etc.) between the spray coating gun 12 and the target object 14. The parameters between the spray coating gun 12 and the target object 14 may be determined by way of a sensor 380 attached to the spray coating gun 12 directly behind the spray tip assembly 300 and on the body 302 of the spray coating gun 12. The position of the sensor 380 behind the spray tip assembly 300 and on the body 302 of the spray coating gun 12 enables removal of the spray tip assembly 300 without disturbing the placement of the sensor 380. The sensor 380 may be capable of sensing the presence or absence of the target object 14. More specifically, the sensor 380 may be configured to monitor distance, velocity, acceleration, angle, direction, or a combination thereof, between the spray coating gun 12 and the target object 14. The sensor 380 may be of any type including, but not limited to, laser, infrared, photoelectric, optical, fiber optic, electromagnetic or electrostatic, microwave, capacitive, piezoelectric, and ultrasonic sensors.

For example, once the distance between the spray coating gun 12 and the target object 14 is determined, the sensor 380 may communicate this distance to a programmable logic controller (PLC) or other automated input/output arrangement. The logic controller 382 may reside either on the spray coating gun 12 or at a remote location to the spray coating gun 12. The logic controller 382 may determine, based on the distance between the spray coating gun 12 and the target object 14, whether the fluid flow rate delivered from the fluid delivery assembly 326 should be adjusted. For instance, if the distance between the spray coating gun 12 and the target object 14 cannot be determined (e.g., no presence detected), the fluid flow rate delivered from the fluid delivery assembly 326 may be stopped until such time that the distance between the spray coating gun 12 and target object 14 can be determined. In addition, the fluid flow rate delivered from the fluid delivery assembly 326 may be varied based on the distance between the spray coating gun 12 and the target object 14. For instance, if the distance between the spray coating gun 12 and the target object 14 decreases, the fluid flow rate delivered from the fluid delivery assembly 326 may be decreased. Similarly, if the distance between the spray coating gun 12 and the target object 14 increases (e.g., within a suitable range while the target object 14 is within a field of view of the spray coating gun 12), the fluid flow rate delivered from the fluid delivery assembly 326 may be increased. In either case, the automatic flow control may be subject to limits, e.g., upper and lower, in both the flow rates and distances for outputting a spray. In other words, if the spray coating gun 12 is either too close or too distant from the target object 14, then the sensor 380 feedback may trigger an automatic shutoff, an alarm, a delayed shutoff, or another suitable corrective action in response.

The fluid flow rate delivered from the fluid delivery assembly 326 may be varied by communicating with a drive 384 located within the internal portion 342 of the fluid valve adjuster 336. The drive 384 may be actuated to counteract the inward movement of the needle valve 334 away from the fluid delivery tip assembly 304. In addition, it may be desirable to actuate the drive 384 without disturbing the position of the trigger 344. In one embodiment, the needle valve 334 and the drive 384 may be configured such that the drive 384 causes the fluid valve assembly 332 to move toward the fluid delivery tip assembly 304 without moving the needle valve 334. For example, the needle valve 334 may be configured to allow the drive 384 to slide coaxially through the needle valve 334 when the drive 384 is actuated. This could be accomplished using a mechanism within the needle valve 334 which allows an inner portion of the needle valve 334 to separate from an outer portion of the needle valve 334. The outer portion of the needle valve 334 would stay in position while the inner portion of the needle valve 334 moves coaxially with the drive 384. In such an embodiment, the trigger 344 would not experience the force exerted by the drive 384. Therefore, the user would not be aware when the drive 384 overrides the user's depression of the trigger 344. It should be noted that this particular embodiment for actuating the drive 384 and for maintaining the position of the trigger 344 while actuating the drive 384 is merely illustrative and should not be construed as limiting. Other embodiments for carrying out these general objectives may be implemented. It should also be noted that the drive 384 may be an electronic drive, pneumatic drive, hydraulic drive, or any combination thereof.

In certain embodiments, the sensor 280, drive 284, and associated logic controller 282 of FIG. 3 may be supplied as a retrofit kit option for existing spray coating guns. In addition, the sensor 280 and drive 284 may communicate through the logic controller 282 via wireless communication technology, such as microwave, radio frequency, and infrared. Similarly, the sensor 380, drive 384, and associated logic controller 382 of FIG. 4 may be supplied as a retrofit kit option for existing spray coating guns. Again, the sensor 380 and drive 384 may communicate through the logic controller 382 via wireless communication technology, such as microwave, radio frequency, and infrared. These retrofit kits may be configured to mount to any existing spray coating gun.

In some embodiments, one or more sensors may be mounted to the head, body, handle, hoses, or a combination thereof, of the spray gun. For example, these sensors may be mounted via clamps, Velcro, adhesives, epoxy, screws, ties, or a combination thereof. Again, these sensors may be wired sensors, wireless sensors, or a combination thereof. Furthermore, the sensors may be configured to sense position, distance, velocity, acceleration, angle, surface temperature, surface morphology, surface wetness, or a combination thereof, of the target object relative to the spray gun. These sensed parameters may be used by an on-board controller to adjust operation of the spray gun. The on-board controller may include a processor, memory, and code disposed on the processor. The on-board controller alternatively may include a programmable logic controller (PLC) or another suitable controller. Similar to the sensors, the on-board controller may be mounted to the head, body, handle, hoses, or a combination thereof, of the spray gun. For example, the on-board controller may be mounted via clamps, Velcro, adhesives, epoxy, screws, ties, or a combination thereof. The controller, in turn, is configured to control operation of one or more valves (e.g., liquid valve, air valve, or both) to adjust an operational state (e.g., on or off), flow rate, or a combination thereof, of the spray gun. Again, the valves may include a pneumatic valve, a hydraulic valve, a motorized valve, a solenoid type valve, or another suitable feedback controllable valve. In each of the disclosed embodiments, the closed loop control provided by the sensors and controlled valves enables more efficient transfer of a coating fluid onto a target object, thereby reducing waste (e.g., into the air) and improving the quality of the coating applied to the target object.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A spray gun, comprising:
a sensor configured to monitor distance between the spray gun and a target object; and
a drive responsive to the sensor, wherein the drive is configured to control a fluid valve of the spray gun based on the distance.

2. The spray gun of claim 1, wherein the drive is configured to close the fluid valve if the sensor indicates an absence, an unacceptable distance, or a combination thereof, of the target object relative to the spray gun.

3. The spray gun of claim 1, wherein the drive is configured to open the fluid valve if the sensor indicates a presence, an acceptable distance, or a combination thereof, of the target object relative to the spray gun.

4. The spray gun of claim 1, wherein the drive is configured to increase flow rate via the fluid valve in response to a sensed increase in distance between the target object and the spray gun, and the drive is configured to decrease flow rate via the fluid valve in response to a sensed decrease in distance between the target object and the spray gun.

5. The spray gun of claim 1, wherein the sensor is a capacitive sensor, an inductive sensor, a photoelectric sensor, a laser sensor, a combination thereof.

6. The spray gun of claim 1, wherein the drive is an electronic drive, a pneumatic drive, a hydraulic drive, or a combination thereof.

7. The spray gun of claim 1, comprising the fluid valve, wherein the fluid valve comprises an air valve, a liquid valve, or a combination thereof.

8. The spray gun of claim 1, comprising an atomization head comprising a liquid exit, an air exit coaxial with the liquid exit, and a plurality of spray shaping orifices directed toward a spray region downstream from the liquid and air exits.

9. The spray gun of claim 1, comprising a trigger configured to engage the fluid valve, wherein the drive varies a position of the fluid valve without moving the trigger.

10. A retrofit kit, comprising:
a feedback-controlled system configured to change fluid flow of a spray gun in response to one or more sensed parameters indicative of condition of a target object, a relationship between the spray gun and the target object, or a combination thereof.

11. The retrofit kit of claim 10, wherein the feedback-controlled system comprises one or more sensors configured to sense position, distance, velocity, acceleration, angle, surface temperature, surface morphology, surface wetness, or a combination thereof, of the target object relative to the spray gun.

12. The retrofit kit of claim 10, wherein the feedback-controlled system comprises a sensor configured to monitor the one or more sensed parameters, an on-board controller configured to communicate with the sensor, and a drive configured to respond to the on-board controller to change the fluid flow.

13. The retrofit kit of claim 12, wherein the sensor comprises a wireless sensor configured to communicate wirelessly with the on-board controller.

14. The retrofit kit of claim 10, wherein the feedback-controlled system is configured to stop fluid flow if the one or more sensed parameter indicates that the target object is not within an acceptable field of view relative to the spray gun, and the feedback-controlled system is configured to start or continue fluid flow if the one or more sensed parameters indicate that the target object is within the acceptable field of view relative to the spray gun.

15. The retrofit kit of claim 10, wherein the feedback-controlled system is configured to increase the fluid flow in response to a sensed increase in distance between the target object and the spray gun, and the feedback-controlled system is configured to decrease the fluid flow in response to a sensed decrease in distance between the target object and the spray gun.

16. A spray controller, comprising:
a control configured to terminate or decrease fluid flow of a spray in response to a first spray stroke away from a target object, and configured to start, continue, or increase fluid flow of the spray in response to a second spray stroke toward the target object.

17. The spray controller of claim 16, wherein the control is responsive to sensor feedback indicative of a distance between the target object and a source of the spray.

18. The spray controller of claim 16, wherein the control is responsive to sensor feedback indicative of a presence and an absence of the target object relative to a source of the spray.

19. The spray controller of claim 16, wherein the control is responsive to sensor feedback indicative of a surface condition of the target object, a velocity of the spray relative to the target object, an angle of the spray relative to the target object, a distance of the spray relative to the target object, or a combination thereof.

20. A method of operation, comprising:
controlling fluid flow of a spray in response to feedback associated with a target object.

21. The method of claim 20, wherein controlling fluid flow comprises increasing transfer efficiency of the spray.

22. The method of claim 20, wherein controlling fluid flow comprises reducing or eliminating spray into air away from the target object.

23. The method of claim 20, wherein controlling fluid flow comprises increasing the fluid flow in response to a sensed increase in distance between the target object and the spray while within an acceptable distance between the target object and the spray, and decreasing the fluid flow in response to a sensed decrease in distance between the target object and the spray while within the acceptable distance.

24. A tangible medium, comprising:
instructions stored on the tangible medium, wherein the instructions comprise code configured to terminate or decrease fluid flow of a spray if the spray is not directed toward a target object, and code configured to start, continue, or increase fluid flow of the spray if the spray is directed toward the target object.

25. The tangible medium of claim 24, wherein the code is responsive to sensor feedback indicative of the presence and absence of the target object relative to a field of view of the spray.
